(19) United States
(12) Patent Application Publication
(10) Pub. No.: US 2013/0264886 A1
(43) Pub. Date: Oct. 10, 2013

(54) NON-CONTACT POWER SUPPLY SYSTEM

(71) Applicant: HITACHI CABLE, LTD., Tokyo (JP)

(72) Inventors: Katsutoshi NAKATANI, Hitachi (JP); Masanori SAGAWA, Kitaibaraki (JP); Kazuo KOTANI, Hitachi (JP); Naofumi CHIWATA, Mito (JP)

(73) Assignee: HITACHI CABLE, LTD., Tokyo (JP)

(21) Appl. No.: 13/786,877

(22) Filed: Mar. 6, 2013

(30) Foreign Application Priority Data
Apr. 6, 2012 (JP) 2012-087211

(51) Int. Cl. H04B 5/00

(52) U.S. Cl. CPC H04B 5/0037
USPC 307/104

(57) ABSTRACT

A non-contact power supply system for supplying power from a power transmission-side AC source to a power receiving-side load in a non-contact manner includes a power transmission-side resonance coil receiving AC power supplied from the AC source, a power receiving-side resonance coil having a resonant frequency causing electromagnetic-coupling to the power transmission-side resonance coil, a power transmission-side transformer disposed between the power transmission-side resonance coil and the AC source, and a power receiving-side transformer disposed between the power receiving-side resonance coil and the load.

The present application is based on Japanese patent application No. 2012-087211 filed on Apr. 6, 2012, the entire contents of which are incorporated herein by reference.

### BACKGROUND OF THE INVENTION

1. Field of the Invention

The invention relates to a non-contact power supply system using an electromagnetic field resonance method.

2. Description of the Related Art

Conventionally, a non-contact power supply system is known in which power is supplied from a power supply side to a power receiving side in a non-contact manner by an electromagnetic field resonance method using an electromagnetic field resonance phenomenon (see, e.g., JP-A-2012-34468).

A resonance-type non-contact power supply system for vehicle disclosed in JP-A-2012-34468 is provided with a power transmission-side resonance coil for receiving power supply from a power source and a power receiving-side resonance coil on a vehicle side for receiving power from the power transmission-side resonance coil.

### SUMMARY OF THE INVENTION

The electromagnetic field resonance phenomenon becomes most efficient when the power transmission-side resonance coil and the power receiving-side resonance coil have the same shape and size and also when power transmission is carried out at a resonant frequency of the power transmission-side and power receiving-side resonance coils, and if a frequency of AC power supplied to the power transmission-side resonance coil deviates from the resonant frequency, power transmission efficiency decreases.

However, if for example, this non-contact power supply system becomes widely used, it is considered that power will be transmitted between resonance coils manufactured by different manufacturers, and there may be a case that, due to difference in a shape or size between or a machining error or an assembly error on the resonance coils, a resonant frequency of the power transmission-side resonance coil is different from that of the power receiving-side resonance coil or that AC power with a frequency deviating from the resonant frequencies of the two resonance coils is supplied to the power transmission-side resonance coil. In such a case, power transmission efficiency from the power transmission side to the power receiving side decreases.

Accordingly, it is an object of the invention to provide a non-contact power supply system that can broaden a frequency band to allow a highly efficient power transmission from the power transmission side to the power receiving side.
(1) According to one embodiment of the invention, a non-contact power supply system for supplying power from a power transmission-side AC source to a power receiving-side load in a non-contact manner comprises:

a power transmission-side resonance coil receiving AC power supplied from the AC source;

a power receiving-side resonance coil having a resonant frequency causing electromagnetic-coupling to the power transmission-side resonance coil;

a power transmission-side transformer disposed between the power transmission-side resonance coil and the AC source; and

a power receiving-side transformer disposed between the power receiving-side resonance coil and the load.

In the above embodiment (1) of the invention, the following modifications and changes can be made.

(i) The power transmission-side transformer is configured such that the number of turns in a primary coil on the AC source side is less than the number of turns in a secondary coil on the power transmission-side resonance coil side,

wherein the power receiving-side transformer is configured such that the number of turns in a primary coil on the power receiving-side resonance coil side is more than the number of turns in a secondary coil on the load side.

(ii) The power transmission-side transformer is configured such that the number of turns in the secondary coil on the power transmission-side resonance coil side is not more than twice the number of turns in the primary coil on the AC source side,

wherein the power receiving-side transformer is configured such that the number of turns in the primary coil on the power receiving-side resonance coil side is not more than twice the number of turns in the secondary coil on the load side.

(iii) The number of turns in the primary coil on the AC source side of the power transmission-side transformer is the same as that in the secondary coil on the load side of the power receiving-side transformer,

wherein the number of turns in the secondary coil on the power transmission-side resonance coil side of the power transmission-side transformer is the same as that in the primary coil on the power receiving-side resonance coil side of the power receiving-side transformer.

(iv) The power transmission-side transformer and the power receiving-side transformer each comprise a toroidal transformer.

### Effects of the Invention

According to one embodiment of the invention, a non-contact power supply system can be provided that can broaden a frequency band to allow a highly efficient power transmission from the power transmission side to the power receiving side.

### BRIEF DESCRIPTION OF THE DRAWINGS

Next, the present invention will be explained in more detail in conjunction with appended drawings, wherein:

FIG. 1 is a schematic configuration diagram illustrating a non-contact power supply system in an embodiment of the present invention;

FIG. 2 is an external view showing a detailed structure of a toroidal transformer;

FIGS. 3A and 3B are perspective views showing details of a power transmission-side resonance coil and a power receiving-side resonance coil, wherein FIG. 3A is viewed from a connector side and FIG. 3B is viewed from an opposite side;

FIG. 4A is a graph showing a relation between transmission loss of power and a frequency of AC power when the numbers of turns in primary and secondary coils of the toroidal transformers are changed and FIG. 4B is an enlarged view showing a section A in FIG. 4A;

FIG. 5A is a graph showing a relation between transmission loss of power and a frequency of AC power in the case that the toroidal transformer is not provided in a power transmission device as Comparative Example and when the number of turns in the toroidal transformer of a power receiving device is changed, and FIG. 5B is an enlarged view showing a section B in FIG. 5A; and

FIG. 6A is a graph showing a relation between transmission loss of power and a frequency of AC power in the case that the toroidal transformer is not provided in the power receiving device as Comparative Example and when the number of turns in the toroidal transformer of the power transmission device is changed, and FIG. 6B is an enlarged view showing a section C in FIG. 6A.

### DETAILED DESCRIPTION OF THE PREFERRED EMBODIMENTS

### Embodiment

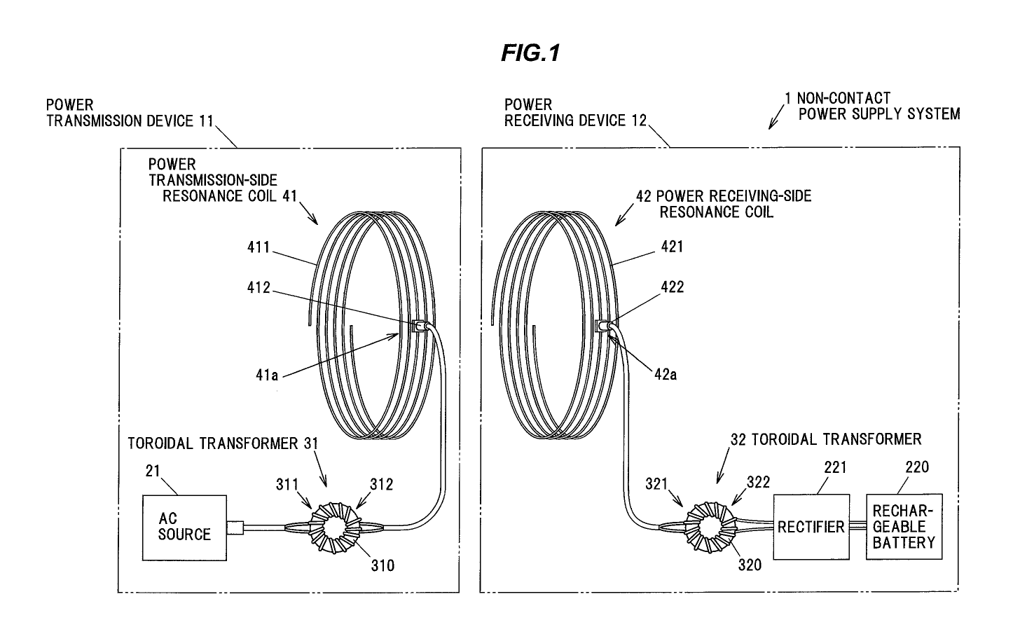

FIG. 1 is a schematic configuration diagram illustrating a non-contact power supply system in the present embodiment.

A non-contact power supply system 1 is to supply power from a power transmission device 11 to a power receiving device 12 in a non-contact manner, and the power receiving device 12 is, e.g., a vehicle having an electric motor as a drive source for running the vehicle or a handheld terminal such as mobile phone.

The power transmission device 11 is provided with an AC source 21, a toroidal transformer 31 as a power transmission-side transformer and a power transmission-side resonance coil 41. The power receiving device 12 is provided with a rechargeable battery 220 as a load, a rectifier 221, a toroidal transformer 32 as a power receiving-side transformer and a power receiving-side resonance coil 42. The non-contact power supply system 1 supplies power from the AC source 21 on the power transmission side to the rechargeable battery 220 on the power receiving side in a non-contact manner by using an electromagnetic resonance phenomenon between the power transmission-side resonance coil 41 and the power receiving-side resonance coil 42.

The AC source 21 outputs AC power having a predetermined frequency by, e.g., a switching element such as transistor.

The toroidal transformer 31 is provided between the AC source 21 and the power transmission-side resonance coil 41, and has a core 310 formed of a ring-shaped magnetic body, a primary winding 311 wound around the core 310 on the AC source 21 side, and a secondary winding 312 also wound around the core 310 on the power transmission-side resonance coil 41 side.

In the power transmission-side resonance coil 41, a winding wire 411 is helically wound and formed in an annular shape, and AC power output from the AC source 21 is supplied, via the toroidal transformer 31, to a feeding point 41a to which a connector 412 is connected. The winding wire 411 is, e.g., an enameled wire in which a conductor made of a highly conductive metal such as copper is covered with enamel. The power transmission-side resonance coil 41 has a resonant frequency corresponding to a frequency of the AC power output from the AC source 21.

The power receiving-side resonance coil 42 is formed in the same shape and size as the power transmission-side resonance coil 41 and has the same resonant frequency as the power transmission-side resonance coil 41. In other words, the power receiving-side resonance coil 42 has a resonant frequency causing electromagnetic-coupling to the power transmission-side resonance coil 41. In addition, in the power receiving-side resonance coil 42, a winding wire 421 is helically wound and formed in an annular shape, and the toroidal transformer 32 is connected to a power point 42a to which a connector 422 is connected. In the present embodiment, each of the winding wire 411 of the power transmission-side resonance coil 41 and the winding wire 421 of the power receiving-side resonance coil 42 is wound five turns.

The toroidal transformer 32 is provided between the power receiving-side resonance coil 42 and the rectifier 221, i.e., between the power receiving-side resonance coil 42 and the rechargeable battery 220, and has a core 320 formed of a ring-shaped magnetic body, a primary winding 321 wound around the core 320 on the power receiving-side resonance coil 42 side, and a secondary winding 322 also wound around the core 320 on the rectifier 221 side.

The rectifier 221 rectifies AC power generated by the secondary winding 322 of the toroidal transformer 32, converts the AC power into DC power and supplies the DC power to the rechargeable battery 220. The rectifier 221 is composed of, e.g., a diode bridge circuit and a smoothing circuit.

The rechargeable battery 220 is a secondary battery which is, e.g., a lithium-ion battery or a nickel hydride battery. The power stored in the rechargeable battery 220 is used for, e.g., driving an electric motor or activating an electronic circuit provided with a CPU (Central Processing Unit), etc.

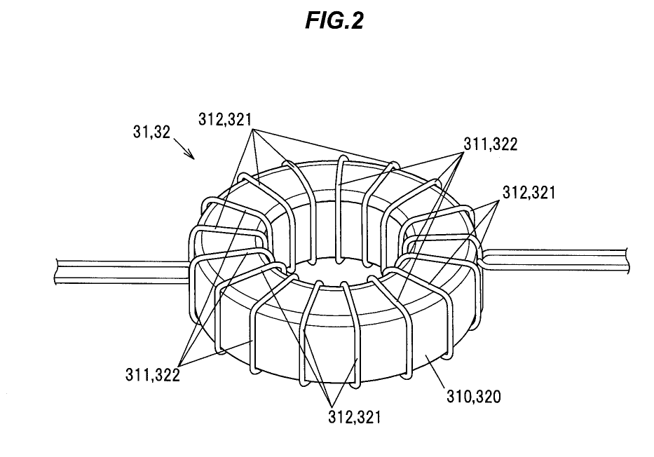

FIG. 2 is an external view showing the toroidal transformers 31 and 32 in more detail. Since the toroidal transformers 31 and 32 have the same structure, reference numerals for components of the toroidal transformer 31 and those of the toroidal transformer 32 are both shown in FIG. 2.

The toroidal transformer 31 is formed by winding the primary winding 311 and the secondary winding 312 around the ring-shaped core 310. In an example shown in FIG. 2, the number of turns in the primary winding 311 is seven and that in the secondary winding 312 is ten. The primary winding 311 and the secondary winding 312 are wound so that each makes a full circle of the core 310.

Likewise, the toroidal transformer 32 is formed by winding the primary winding 321 and the secondary winding 322 around the ring-shaped core 320. In the example shown in FIG. 2, the number of turns in the primary winding 321 is ten and that in the secondary winding 322 is seven. The primary winding 321 and the secondary winding 322 are wound so that each makes a full circle of the core 320.

As described above, in the present embodiment, the number of turns in the primary winding 311 of the toroidal transformer 31 is the same as that in the secondary winding 322 of the toroidal transformer 32, and the number of turns in the secondary winding 312 of the toroidal transformer 31 is the same as that in the primary winding 321 of the toroidal transformer 32. In the toroidal transformer 31, the number of turns in the primary winding 311 is less than that in the secondary winding 312. And in the toroidal transformer 32, the number of turns in the primary winding 321 is more than that in the secondary winding 322.

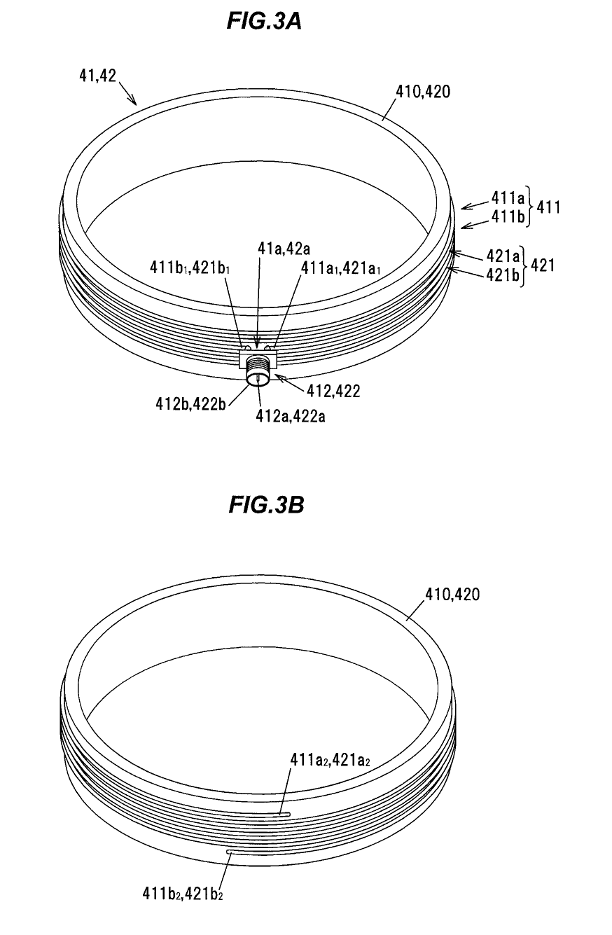

FIGS. 3A and 3B are perspective views showing the power transmission-side resonance coil 41 and the power receiving-side resonance coil 42 in more detail, wherein FIG. 3A is viewed from the connector 412/422 side and FIG. 3B is viewed from an opposite side. Since the power transmission-side resonance coil 41 and the power receiving-side resonance coil 42 have the same structure, reference numerals for components of the power transmission-side resonance coil 41 and those of the power receiving-side resonance coil 42 are both shown in FIG. 3.

In the power transmission-side resonance coil 41, the winding wire 411 is helically wound around an outer periphery of a resin cylindrical member 410. The winding wire 411 is composed of a first winding wire 411a helically wound from the feeding point 41a connected to the connector 412 toward one axial direction of the cylindrical member 410, and a second winding wire 411b helically wound from the feeding point 41a toward the opposite axial direction of the cylindrical member 410.

The connector 412 has a first contact point 412a having a needle-like shape and a second contact point 412b having a cylindrical shape and provided so as to surround the first contact point 412a. An end 411a₁ of the first winding wire 411a is connected to the first contact point 412a and an end 411b₁ of the second winding wire 411b is connected to the second contact point 412b. An opposite end 411a₂ of the first winding wire 411a and an opposite end 411b₂ of the second winding wire 411b are open.

In the non-contact power supply system 1 configured as described above, the AC power output from the AC source 21 is boosted by the toroidal transformer 31 and is then supplied to the power transmission-side resonance coil 41. This oscillates the power transmission-side resonance coil 41, and then, the power transmission-side resonance coil 41 and the power receiving-side resonance coil 42 are electromagnetically-coupled to each other by resonance therebetween. As a result, power is transmitted from the power transmission-side resonance coil 41 to the power receiving-side resonance coil 42 in a non-contact manner.

The power transmitted to the power receiving-side resonance coil 42 is lowered by the toroidal transformer 32, is rectified by the rectifier 221 and is then supplied to the rechargeable battery 220. The rechargeable battery 220 stores the supplied power by a chemical reaction.

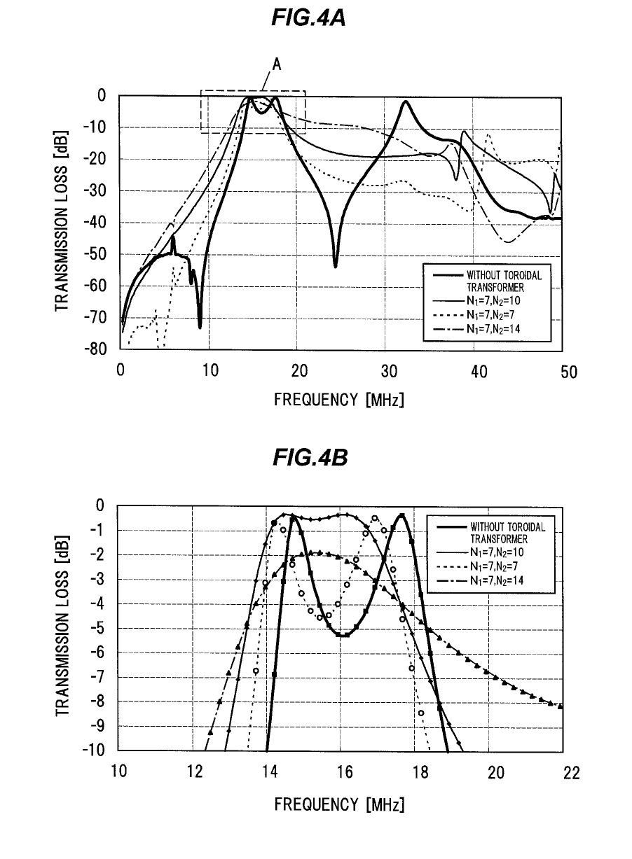

FIG. 4A is a graph showing, in comparison to the case of not providing the toroidal transformers 31 and 32, a relation between transmission loss of power and a frequency of the AC power output from the AC source 21 in the non-contact power supply system 1 of the present embodiment when the numbers of turns in the primary windings 311, 321 and the secondary windings 312, 322 of the toroidal transformers 31 and 32 are changed and FIG. 4B is an enlarged view showing a section A in FIG. 4A.

In this test, transmission loss was measured by changing the number of turns in the secondary winding 312 of the toroidal transformer 31 and that in the primary winding 321 of the toroidal transformer 32 between three levels, which are 7, 10 and 14 turns, while the number of turns in the primary winding 311 of the toroidal transformer 31 and that in the secondary winding 322 of the toroidal transformer 32 were both fixed to be 7. Hereinafter, a symbol N₁ represents the number of turns in the primary winding 311 of the toroidal transformer 31 and also that in the secondary winding 322 of the toroidal transformer 32, and a symbol N₂ represents the number of turns in the secondary winding 312 of the toroidal transformer 31 and also that in the primary winding 321 of the toroidal transformer 32.

In the graph, a curved line indicated by a thick solid line with “▪ (filled squares)” shows a characteristic in the case of not providing the toroidal transformers 31 and 32, a curved line indicated by a thin solid line with “♦ (filled diamonds)” shows a characteristic in the case where N₁=7 and N₂=10, a curved line indicated by a dotted line with “◯ (open circles)” shows a characteristic in the case where N₁=7 and N₂=7, and a curved line indicated by a dashed-dotted line with “▴ (filled triangles)” shows a characteristic in the case where N₁=7 and N₂=14.

As shown in the graph, in the case of not providing the toroidal transformers 31 and 32, steep rises appear in frequency domains on both sides of 16 MHz. In this case, in order to reduce transmission loss to, e.g., not more than 3 dB, the frequency of the AC power output from the AC source 21 needs to be adjusted so as to be within narrow bands around 14.7 MHz and around 17.8 MHz.

On the other hand, in the case where N₁=7 and N₂=10, transmission loss is reduced to not more than 3 dB in a relatively wide band from about 13.7 MHz to about 17.4 MHz. In addition, in the case where N₁=7 and N₂=14, transmission loss is reduced to not more than 3 dB in a band from about 14.1 MHz to about 17 MHz even though the bandwidth is narrower than the case where N₁=7 and N₂ =10. In the case where N₁=7 and N₂=7, transmission loss increases at around 15.5 MHz and a rise where transmission loss decreases appears in bands on both sides of the increased portion. Even in this case, however, a bandwidth in which transmission loss is not more than 3 dB is wider than the case of not providing the toroidal transformers 31 and 32.

When the toroidal transformers 31 and 32 are provided such that the numbers of turns in the primary and secondary windings 311, 312, 321 and 322 satisfy the relation of N₁≦N₂≦2N₁, i.e., the toroidal transformer 31 is configured so that the number of turns in the secondary winding 312 (N₂) is less than twice the number of turns in the primary winding 311 (N₁) and also the toroidal transformer 32 is configured so that the number of turns in the primary winding 321 (N₂) is less than twice the number of turns in the secondary winding 322 (N₁) as described above, it is possible to realize transmission loss of not more than 3 dB in a wider band than the case of providing the toroidal transformers 31 and 32.

### COMPARATIVE EXAMPLE 1

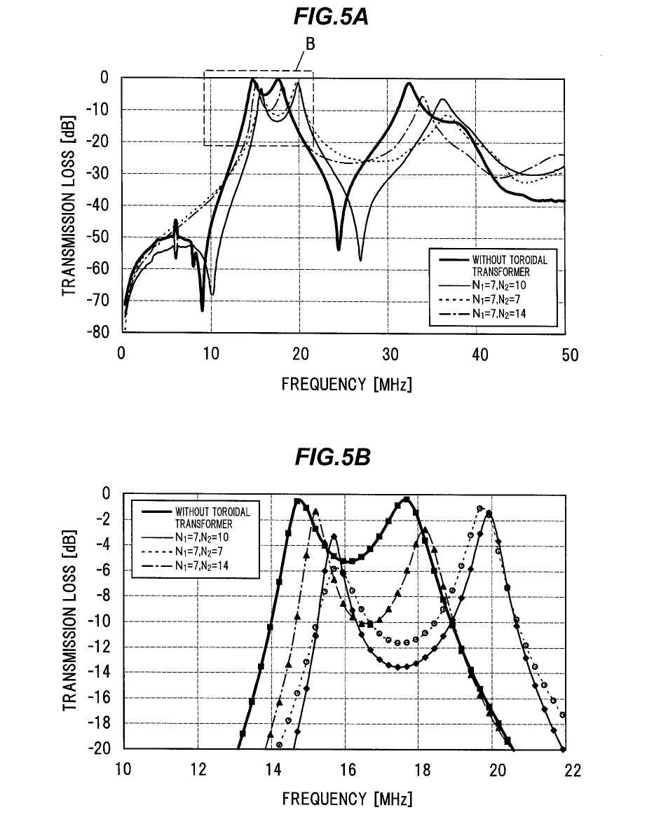

FIG. 5A is a graph showing, in comparison to the case of not providing the toroidal transformers 31 and 32, a relation between transmission loss of power and a frequency of the AC power output from the AC source 21 in the case that the toroidal transformer 32 is provided in the power receiving device 12 and the AC source 21 is directly connected to the power transmission-side resonance coil 41 without providing the toroidal transformer 31 in the power transmission device 11 as Comparative Example and when, in the toroidal transformer 32, the number of turns in the secondary winding 322 is fixed to be 7 and the number of turns in the primary winding 321 is changed between three levels, which are 7, 10 and 14 turns, and FIG. 5B is an enlarged view showing a section B in FIG. 5A.

As shown in FIGS. 5A and 5B, when the toroidal transformer 31 is not provided in the power transmission device 11, transmission loss is larger than the case of not providing the toroidal transformers 31 and 32 even though the number of turns in the primary winding 321 is changed. As a result, a bandwidth in which the transmission loss is not more than 3 dB is not present or is narrower than the case of not providing the toroidal transformers 31 and 32.

### COMPARATIVE EXAMPLE 2

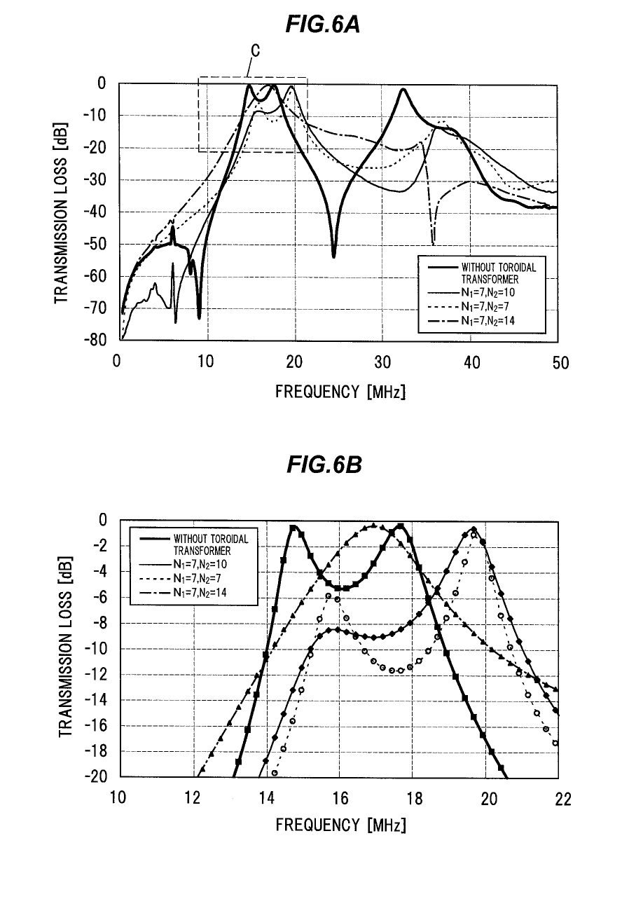

FIG. 6A is a graph showing, in comparison to the case of not providing the toroidal transformers 31 and 32, a relation between transmission loss of power and a frequency of the AC power output from the AC source 21 in the case that the toroidal transformer 31 is provided in the power transmission device 11 and the power receiving-side resonance coil 42 is directly connected to the rectifier 221 without providing the toroidal transformer 32 in the power receiving device 12 as Comparative Example and when, in the toroidal transformer 31, the number of turns in the primary winding 311 is fixed to be 7 and the number of turns in the secondary winding 312 is changed between three levels, which are 7, 10 and 14 turns, and FIG. 6B is an enlarged view showing a section C in FIG. 6A.

As shown in FIGS. 6A and 6B, in the case that the toroidal transformer 32 is not provided in the power receiving device 12, transmission loss is not more than 3 dB in a wider bandwidth than the case of not providing the toroidal transformers 31 and 32 when the number of turns in the secondary winding 312 is 14, however, the bandwidth in which the transmission loss is not more than 3 dB is narrower than the case of not providing the toroidal transformers 31 and 32 when the number of turns in the secondary winding 312 is 7 or 10.

### Effects of the Embodiment

According to the present embodiment, it is possible to broaden a frequency band which allows highly efficient power transmission (transmission loss of not more than 3 dB) from the power transmission device 11 to the power receiving device 12.

Although the embodiment of the invention has been described, the invention according to claims is not to be limited to the above-mentioned embodiment. Further, please note that all combinations of the features described in the embodiment are not necessary to solve the problem of the invention.

In addition, various modifications can be implemented without departing the gist of the invention. For example, a configuration other than that shown in FIG. 1, etc., may be added to the power transmission device 11 and the power receiving device 12. Alternatively, some elements (the rectifier 221, etc.) in the configuration shown in FIG. 1, etc., may be omitted. In addition, although the case where the toroidal transformer is used as a transformer has been described in the embodiment, the form of the transformer is not limited to the toroidal transformer and it is possible to use various forms of transformers. In addition, the shape, etc., of the power transmission-side resonance coil 41 and the power receiving-side resonance coil 42 is not specifically limited, neither.

What is claimed is:

1. A non-contact power supply system for supplying power from a power transmission-side AC source to a power receiving-side load in a non-contact manner, comprising:
a power transmission-side resonance coil receiving AC power supplied from the AC source;
a power receiving-side resonance coil having a resonant frequency causing electromagnetic-coupling to the power transmission-side resonance coil;
a power transmission-side transformer disposed between the power transmission-side resonance coil and the AC source; and
a power receiving-side transformer disposed between the power receiving-side resonance coil and the load.

2. The non-contact power supply system according to claim 1, wherein the power transmission-side transformer is configured such that the number of turns in a primary coil on the AC source side is less than the number of turns in a secondary coil on the power transmission-side resonance coil side, and
wherein the power receiving-side transformer is configured such that the number of turns in a primary coil on the power receiving-side resonance coil side is more than the number of turns in a secondary coil on the load side.

3. The non-contact power supply system according to claim 2, wherein the power transmission-side transformer is configured such that the number of turns in the secondary coil on the power transmission-side resonance coil side is not more than twice the number of turns in the primary coil on the AC source side, and
wherein the power receiving-side transformer is configured such that the number of turns in the primary coil on the power receiving-side resonance coil side is not more than twice the number of turns in the secondary coil on the load side.

4. The non-contact power supply system according to claim 2, wherein the number of turns in the primary coil on the AC source side of the power transmission-side transformer is the same as that in the secondary coil on the load side of the power receiving-side transformer, and
wherein the number of turns in the secondary coil on the power transmission-side resonance coil side of the power transmission-side transformer is the same as that in the primary coil on the power receiving-side resonance coil side of the power receiving-side transformer.

5. The non-contact power supply system according to claim 1, wherein the power transmission-side transformer and the power receiving-side transformer each comprise a toroidal transformer.
